(19) United States
(12) Patent Application Publication
(10) Pub. No.: US 2018/0141656 A1
(43) Pub. Date: May 24, 2018

(54) METHOD AND SYSTEM FOR MONITORING OPERATIONAL STATUS OF DRONE

(71) Applicant: Sharper Shape Oy, Espoo (FI)

(72) Inventors: Tero Heinonen, Jarvenpaa (FI); Ville Koivuranta, Helsinki (FI)

(21) Appl. No.: 15/358,523

(22) Filed: Nov. 22, 2016

(51) Int. Cl. B64C 39/02; G08G 5/00; G05D 1/00; G05D 1/10

(52) U.S. Cl. CPC B64C 39/024; G08G 5/0091; G08G 5/003; G05D 1/101; G05D 1/0011; G05D 1/0061

(57) ABSTRACT

A method of monitoring an operational status of a drone includes capturing statistical data pertaining to a plurality of flight parameters for a flight route using at least one drone whilst the drone flies substantially along the flight route at least once. Transmitting the statistical data to a Ground Control Station and analyzing the statistical data to determine at least a minimum and a maximum threshold for each of the flight parameters. Storing reference data indicative of at least the minimum and the maximum threshold for each flight parameter at the at least one drone. Capturing flight data at the at least one drone and comparing the flight data with the reference data, and executing at least one pre-defined action, if at least one of the plurality of flight parameters falls below its minimum threshold or exceeds its maximum threshold as indicated by the reference data.

### TECHNICAL FIELD

The present disclosure relates generally to drones; and more specifically, to a method and system for monitoring an operational status of a drone.

### BACKGROUND

Drones are unmanned aerial vehicles without humans such as pilots and/or passengers on board. Further, drones may be operated completely autonomously using on-board computers, semi-autonomously using a Ground Control Station (GCS) and the on-board computers, or manually by an operator at the GCS. Nowadays, drones may be used for real-world applications (or missions) such as performing routine inspection of assets (such as buildings, oil pipes, and so forth), aerial photography, and so forth.

Further, drones may be required to fly along a fixed flight route periodically for real-world applications such as the inspection of assets along the fixed flight route. While flying, drones may encounter problems, such as difficult weather conditions, drone malfunction, break of connection with the GCS, and so forth. It may be evident that such problems need to be detected and timely addressed to avoid failure of the mission and/or damage to the drones.

The existing techniques for detection of the above mentioned problems are slow and inefficient. In case of semi-autonomous and manually operated drones, detection of such problems may be performed by the operator at the GCS leading to considerable likelihood of delay and/or errors in detection. Furthermore, timely execution of corrective action to address the aforementioned problems may be interrupted if the connection between the GCS and drones is broken.

Therefore, in light of the foregoing discussion, there exists a need to overcome the aforementioned drawbacks associated with detecting and addressing problems occurring while operation of drones.

### SUMMARY

The present disclosure seeks to provide a method of monitoring an operational status of a drone. The present disclosure also seeks to provide a system for monitoring an operational status of a drone. The present disclosure seeks to provide a solution to the existing problem of inefficient detection of problems during operation of drones. An aim of the present disclosure is to provide a solution that overcomes at least partially the problems encountered in prior art, and provides a simple, reliable, easy to implement solution for monitoring operation of drones for timely detection of problems and execution of corrective actions.

In one aspect, an embodiment of the present disclosure provides a method of monitoring an operational status of a drone, the method comprising
capturing statistical data for a flight route, wherein the statistical data is captured using at least one drone, whilst the at least one drone flies substantially along the flight route at least once, the statistical data pertaining to a plurality of flight parameters,
transmitting to a Ground Control Station the statistical data for the flight route from the at least one drone,
analyzing the statistical datato determine at least a minimum threshold and a maximum threshold for each of the plurality of flight parameters,
storing at the at least one drone reference data indicative of at least the minimum threshold and the maximum threshold for each of the plurality of flight parameters for the flight route,
capturing at the at least one drone flight data for the flight route and comparing the flight data with the reference data, whilst flying substantially along the flight route, and
executing at least one pre-defined action, if at least one of the plurality of flight parameters for the flight route falls below its minimum threshold or exceeds its maximum threshold as indicated by the reference data.

In another aspect, an embodiment of the present disclosure provides a system for monitoring an operational status of a drone, the system comprising
a Ground Control Station, and
at least one drone communicably coupled to the Ground Control Station, the at least one drone being configured to
   capture statistical data for a flight route whilst flying substantially along the flight route at least once, the statistical data pertaining to a plurality of flight parameters,
   transmit to a Ground Control Station the statistical data for the flight route from the at least one drone,
   store reference data indicative of at least a minimum threshold and a maximum threshold for each of the plurality of flight parameters for the flight route,
   capture flight data for the flight route and compare the flight data with the reference data, whilst flying substantially along the flight route, and
   execute at least one pre-defined action, if at least one of the plurality of flight parameters for the flight route falls below its minimum threshold or exceeds its maximum threshold as indicated by the reference data,

wherein the Ground Control Station is configured to analyze the statistical data to determine at least the minimum threshold and the maximum threshold for each of the plurality of flight parameters.

Embodiments of the present disclosure substantially eliminate or at least partially address the aforementioned problems in the prior art, and enables efficient monitoring of operational status of a drone.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment for implementing a system for monitoring an operational status of a drone, in accordance with an embodiment of the present disclosure;

FIG. 2 is a schematic illustration of the system for monitoring the operational status of the drone, in accordance with different embodiment of the present disclosure; and

FIG. 3 is an illustration of steps of a method of monitoring an operational status of a drone, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of monitoring an operational status of a drone, the method comprising:
capturing statistical data for a flight route, wherein the statistical data is captured using at least one drone, whilst the at least one drone flies substantially along the flight route at least once, the statistical data pertaining to a plurality of flight parameters;
transmitting, to a Ground Control Station, the statistical data for the flight route from the at least one drone,
analyzing the statistical data at the Ground Control Station to determine at least a minimum threshold and a maximum threshold for each of the plurality of flight parameters;
storing, at the at least one drone, reference data indicative of at least the minimum threshold and the maximum threshold for each of the plurality of flight parameters for the flight route;
capturing, at the at least one drone, flight data for the flight route and comparing the flight data with the reference data, whilst flying substantially along the flight route; and
executing at least one pre-defined action, if at least one of the plurality of flight parameters for the flight route falls below its minimum threshold or exceeds its maximum threshold as indicated by the reference data.

In another aspect, an embodiment of the present disclosure provides a system for monitoring an operational status of a drone, the system comprising:
a Ground control station, and
at least one drone communicably coupled to the Ground Control Station, the at least one drone being configured to:
   capture statistical data for a flight route whilst flying substantially along the flight route at least once, the statistical data pertaining to a plurality of flight parameters;
   transmit, to a Ground Control Station, the statistical data for the flight route from the at least one drone;
   store reference data indicative of at least the minimum threshold and the maximum threshold for each of the plurality of flight parameters for the flight route;
   capture flight data for the flight route and compare the flight data with the reference data, whilst flying substantially along the flight route; and
   execute at least one pre-defined action, if at least one of the plurality of flight parameters for the flight route falls below its minimum threshold or exceeds its maximum threshold as indicated by the reference data;

wherein the Ground Control Station is configured to analyze the statistical data to determine at least the minimum threshold and the maximum threshold for each of the plurality of flight parameters.

The present disclosure provides a method and a system for monitoring an operational status of a drone. The method and system of the present disclosure defines safety limits for various flight parameters during operation of the drone. The system determines deviation of one or more flight parameters below or above the safety limits in real time or near-real time, thereby enabling execution of timely corrective action to avoid failure and loss of the drone. Also, the method and system of the present disclosure updates the safety limits in near-real time based on gathered flight data. Therefore, problems encountered during operation of the drone are detected promptly and addressed suitably. Furthermore, use of various data (such as statistical data, reference data, flight data and environmental data) to update the flight parameters along the flight route, increases the reliability of operation of drone.

The system for monitoring an operational status of a drone comprises at least one drone and a GCS communicably coupled to the at least one drone.

In an embodiment, the at least one drone may be an aircraft without a pilot and/or passengers on board, such as multicopter. Specifically, the drone may be used for real-world applications such as collection of asset-related data, surveillance, aerial photography, and so forth. In an example, the at least one drone may be used for inspection of assets such as power line pylons, oil pipes, bridges, buildings, and so forth.

In an embodiment, the at least one drone may comprise various components including, but not limited to, an engine, a power source such as a battery, a memory unit, a clock, a Global Positioning System (GPS), a compass and a configuration of sensors. Specifically, the battery may provide electrical power to the various components of the at least one drone. In one embodiment, the configuration of sensors may comprise altimeters, accelerometers, gyroscopes, magnetometers, infrared sensors, LiDAR sensors, corona detectors, radiation detectors and so forth.

The GCS is a ground control station communicably coupled to the at least one drone. Specifically, the GCS may include communication means (such as a transceiver) to communicate with the drone via a network, such as radio network. Optionally, the network may be a bidirectional network to facilitate two-way communication therethrough. In another embodiment, the GCS may be a mobile device (such as a remote control device) communicably coupled to the at least one drone. According to an embodiment, the GCS may include equipment such as processors, memory, display screens, and so forth.

In an embodiment, operation of the at least one drone may be controlled completely autonomously using on-board computers. In another embodiment, operation of the at least one drone may be controlled at least partially by the Ground Control Station. In such embodiment, a human operator at the GCS may operate the at least one drone.

The at least one drone is configured to capture statistical data for a flight route whilst flying substantially along the flight route at least once, the statistical data pertaining to a plurality of flight parameters. It may be evident that the at least one drone may fly along the same flight route more than once to gather a significant amount of statistical data for the flight route. In an embodiment, the statistical data may be captured as a function of at least one of flight duration, and geo location. Specifically, the statistical data may relate to variation of the plurality of flight parameters with respect to at least one of flight duration and geo location of the at least one drone. Further, the flight duration that may be determined using the clock of the at least one drone, and the geo location may be captured using at least the Global Positioning System (GPS).

According to an embodiment, the plurality of flight parameters may include at least one of a temperature of the engine of drone, a power consumption of the drone, a charging level of the battery of the drone, and sensor data measured by the configuration of sensors of the drone. In an embodiment, the plurality of flight parameters may further include Global Positioning System parameters (or GPS parameters) of the at least one drone. In an example, the statistical data may pertain to the GPS parameters obtained using the Global Positioning System (GPS) of the at least one drone. Examples of the GPS parameters include, but are not limited to, latitudinal and longitudinal coordinates of the at least one drone, uncertainty of estimated geo location of the at least one drone, and number of GPS satellites visible to the at least one drone for identifying the geo location thereof. In an example, the statistical data may pertain parameters and measurements of the radio communication path between the drone and GCS such as latency, signal strength, bandwidth, jitter and/or bit error rate.

In another example, the statistical data may comprise navigation data of the at least one drone. Specifically, the navigation data may comprise various parameters captured through the flight duration such as compass reading, accelerometer reading, height above ground, angular velocity, angular acceleration, magnetic field and so forth.

According to an embodiment, the statistical data for the flight route is captured throughout the flight duration at pre-defined time intervals. Specifically, the captured statistical data may be saved and periodically updated in the memory unit of the at least one drone. For example, the pre-defined time interval may be 10 milliseconds.

Further, the at least one drone is configured to transmit, to the Ground Control Station, the statistical data for the flight route from the at least one drone. The GCS is configured to analyze the statistical data to determine at least a minimum threshold and a maximum threshold for each of the plurality of flight parameters. In an example, the maximum threshold for temperature of the engine of the at least one drone may be 140° C., and the minimum threshold for the temperature of the engine of the at least one drone may be 100° C. It may be evident that the statistical data for the flight route is transmitted from the at least one drone to the GCS via the network.

In an embodiment, analyzing the statistical data to determine at least the minimum threshold and the maximum threshold for each of the plurality of flight parameters comprises determining trends in the captured statistical data, and identifying safety limits to ascertain at least the minimum threshold and the maximum threshold. Specifically, the minimum threshold may correspond to a lower safety limit and the maximum threshold may correspond to an upper safety limit for the flight parameters. It may be evident that accuracy (or correctness) of the minimum and maximum thresholds may be higher when the statistical data is captured over a large number of flights of the at least one drone along the same flight route.

Thereafter, the at least one drone is configured to store reference data indicative of at least the minimum threshold and the maximum threshold for each of the plurality of flight parameters for the flight route. Specifically, the reference data may be stored in the memory unit of the at least one drone. It may be evident that the reference data may be transmitted to the at least one drone from the GCS via the network.

In an embodiment, the reference data may be indicative of at least the minimum threshold and the maximum threshold for each of the plurality of flight parameters as a function of at least one of flight duration, and geo location. For example, the reference data may include minimum and maximum thresholds of temperature of the engine of the at least one drone, during takeoff, during asset inspection, and during landing of the at least one drone.

The at least one drone is further configured to capture flight data for the flight route and compare the flight data with the reference data, whilst flying substantially along the flight route. In an embodiment, the flight data may be captured as a function of at least one of flight duration, and geo location. It may be evident that the flight data pertains to the plurality of flight parameters described previously and may be captured using the configuration of sensors of the at least one drone.

In an embodiment, the captured flight data is compared with the reference data in real time or near-real time. Specifically, the comparison may be performed at the at least one drone so as to minimize time delay in identifying inconsistencies between the captured flight data and the stored reference data. Examples of such inconsistencies include, but are not limited to, value of a flight parameter falling below the minimum threshold thereof, and value of the flight parameter exceeding the maximum threshold thereof. It may be evident that minimizing time delay in identifying the inconsistencies may facilitate timely execution of corrective action for safe operation of the at least one drone. Moreover, performing the comparison at the at least one drone may facilitate the timely execution of corrective action even when connectivity between the at least one drone and the GCS is limited or broken.

In another embodiment, the captured flight data and the reference data may be compared at the Ground Control Station. In a yet further embodiment, the Ground Control Station comprises a cloud computing system. In this case, the various analysis steps may be carried out at the cloud computing system.

Thereafter, the at least one drone is configured to execute at least one pre-defined action, if at least one of the plurality of flight parameters for the flight route falls below its minimum threshold or exceeds its maximum threshold as indicated by the reference data. It may be evident that execution of the at least one pre-defined action may be critical to success of a mission of the drone.

In an embodiment, the pre-defined action may be selected from the group consisting of compensating a value of the at least one of the plurality of flight parameters based upon environmental data collected for the flight route, aborting the flight and returning to the Ground Control Station, and switching the at least one drone to a manual flight mode. It may be evident that the pre-defined actions constitute corrective actions for safe operation of the at least one drone. In an embodiment, the at least one pre-defined action may be executed in real time or near-real time.

In an embodiment, the GCS may be configured to collect environmental data for the flight route, wherein the environmental data may be indicative of weather conditions prevailing at a geo location of the flight route at the time of the flight. In an example, the environmental data may comprise at least one of temperature, wind speed, wind direction, humidity, precipitation, and so forth at the geo location of the flight route. In one embodiment, the environmental data may be collected by the GCS from a weather station via the network, such as radio network or Internet.

In an example, a value of power consumption of the at least one drone may be compensated based upon environmental data such as wind speed. Specifically, the power consumption may be increased if the wind speed along the flight route is high.

According to an embodiment the at least one drone may be further configured to transmit the flight data from the at least one drone to the Ground Control Station, and the GCS may be configured to augment the statistical data with the flight data, and the at least one drone may be further configured to update the reference data based upon the flight data of the at least one drone. Specifically, the flight data may be augmented to the statistical data at the GCS to maintain an up to date record of data at the Ground Control Station. Further, the reference data may be updated based upon the flight data to maintain the up to date record of data at the at least one drone. It may be evident that maintaining up to date data at both the at least one drone and the GCS may be critical to successful operation of the at least one drone. In such instance, the up to date record of reference data may be used during subsequent flights of the at least one drone along the flight route to provide an updated value of minimum threshold and maximum threshold for each of the plurality of flight parameters.

### DETAILED DESCRIPTION OF THE DRAWINGS

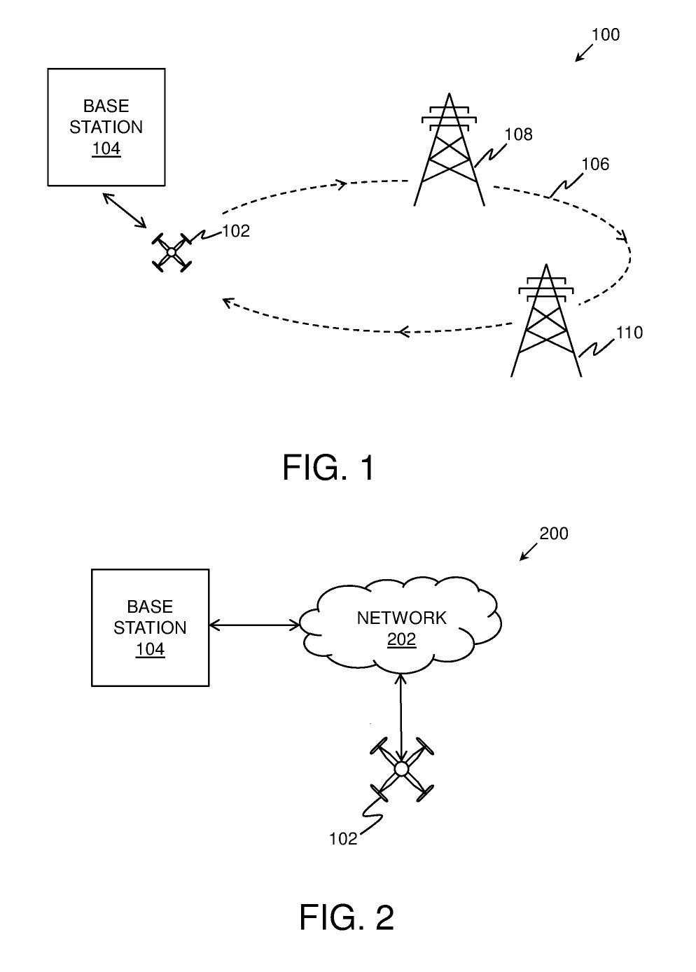

Referring to FIG. 1, illustrated is a schematic illustration of an environment 100 for implementing a system for monitoring an operational status of a drone 102, in accordance with an embodiment of the present disclosure. The environment 100 includes the drone 102 and a GCS 104 communicably coupled to the drone 102. Optionally, operation of the drone 102 may be at least partially controlled by the GCS 104. The drone 102 is configured to fly substantially along a flight route 106 at least once for inspection of assets 108 and 110.

Referring to FIG. 2, illustrated is a schematic illustration of the system 200 for monitoring the operational status of the drone 102, in accordance with an embodiment of the present disclosure. As shown, the system 200 includes the GCS 104 communicably coupled to the given drone 102 via a network 202. As shown, the network 202 is a bidirectional network to facilitate two-way communication therethrough. In an example, the network 202 facilitates communication of statistical data and flight data from the drone 102, to the Ground Control Station 104. In another example, the network 202 facilitates communication of reference data based upon the flight data from the GCS 104 to the drone 102.

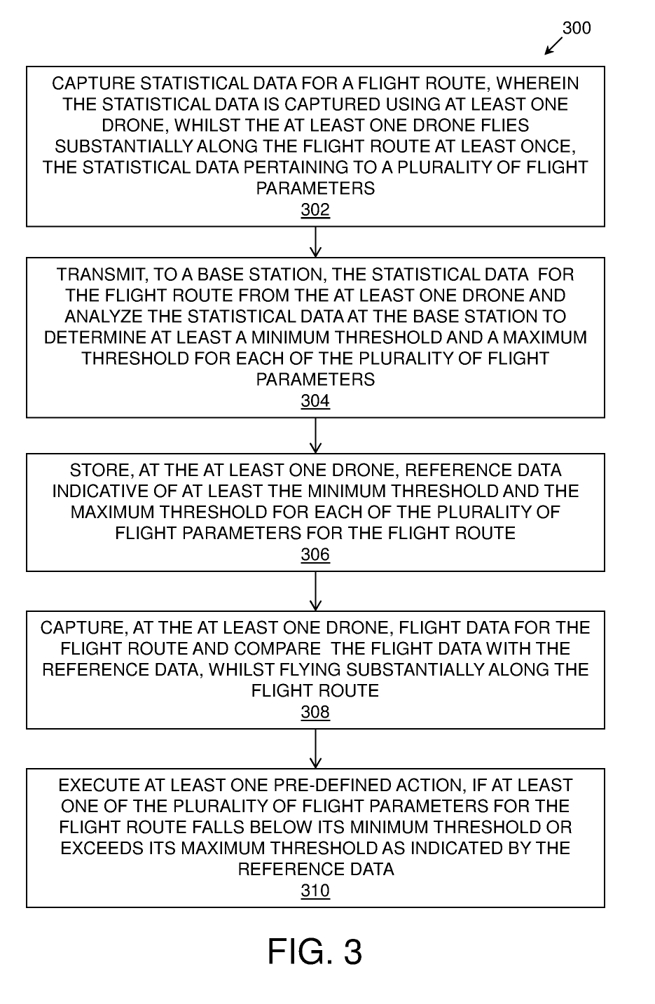

Referring to FIG. 3, illustrated are steps of a method 300 of monitoring an operational status of a drone (such as the drone 102 of FIGS. 1, and 2), in accordance with an embodiment of the present disclosure. At step 302, statistical data for a flight route is captured, wherein the statistical data for a flight route is captured using at least one drone, whilst the at least one drone flies substantially along the flight route at least once, the statistical data pertaining to a plurality of flight parameters. At step 304, statistical data for the flight route is transmitted from the at least one drone to a GCS and the statistical data is analysed at the GCS to determine at least a minimum threshold and a maximum threshold for each of the plurality of flight parameters. At step 306, reference data indicative of at least the minimum threshold and the maximum threshold for each of the plurality of flight parameters for the flight route, is stored at the at least one drone. At step 308, at the at least one drone, flight data for the flight route is captured, and the flight data is compared with the reference data, whilst flying substantially along the flight route. At step 310, at least one pre-defined action is executed, if at least one of the plurality of flight parameters for the flight route falls below its minimum threshold or exceeds its maximum threshold as indicated by the reference data.

The steps 302 to 310 are only illustrative and other alternatives can also be provided where one or more steps are added, one or more steps are removed, or one or more steps are provided in a different sequence without departing from the scope of the claims herein. For example, in the method 300 the statistical data and the flight data may be captured as a function of at least one of flight duration, and geo location. In another example, in the method 300, the reference data may be indicative of at least the minimum threshold and the maximum threshold for each of the plurality of flight parameters as a function of at least one of flight duration, and geo location. Optionally, the plurality of flight parameters may include at least one of a temperature of an engine of a drone, a power consumption of the drone, a charging level of a battery of the drone, and sensor data measured by a configuration of sensors of the drone. In an example, the method 300 may further comprise transmitting, to the Ground Control Station, the flight data from the at least one drone, the GCS augmenting the statistical data with the flight data, and updating, at the at least one drone, the reference data based upon the flight data of the at least one drone. Further, the method 300 may comprise collecting, at the Ground Control Station, environmental data for the flight route, wherein the environmental data is indicative of weather conditions prevailing at a geo location of the flight route at the time of the flight. Optionally, in the method 300, the at least one pre-defined action may be selected from the group consisting of compensating a value of the at least one of the plurality of flight parameters based upon environmental data collected for the flight route, aborting the flight and returning to the Ground Control Station, and switching the at least one drone to a manual flight mode.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of monitoring an operational status of a drone, the method comprising:
capturing statistical data for a flight route, wherein the statistical data is captured using at least one drone, whilst the at least one drone flies substantially along the flight route at least once, the statistical data pertaining to a plurality of flight parameters;
transmitting to a Ground Control Station the statistical data for the flight route from the at least one drone,
analyzing the statistical data to determine at least a minimum threshold and a maximum threshold for each of the plurality of flight parameters;
storing, at the at least one drone, reference data indicative of at least the minimum threshold and the maximum threshold for each of the plurality of flight parameters for the flight route;
capturing, at the at least one drone, flight data for the flight route and comparing the flight data with the reference data, whilst flying substantially along the flight route; and
executing at least one pre-defined action, if at least one of the plurality of flight parameters for the flight route falls below its minimum threshold or exceeds its maximum threshold as indicated by the reference data.

2. The method of claim 1, wherein the statistical data and the flight data are captured as a function of at least one of flight duration, and geo location.

3. The method of claim 2, wherein the reference data is indicative of at least the minimum threshold and the maximum threshold for each of the plurality of flight parameters as a function of at least one of flight duration, and geo location.

4. The method of claim 1, wherein the plurality of flight parameters include at least one of a temperature of an engine of a drone, a power consumption of the drone, a charging level of a battery of the drone, and sensor data measured by a configuration of sensors of the drone.

5. The method of claim 1, wherein the method further comprises:
transmitting to the Ground Control Station the flight data from the at least one drone, the Ground Control Station augmenting the statistical data with the flight data; and
updating, at the at least one drone, the reference data based upon the flight data of the at least one drone.

6. The method of claim 1, the method further comprises collecting, at the Ground Control Station, environmental data for the flight route, wherein the environmental data is indicative of weather conditions prevailing at a geo location of the flight route at the time of the flight.

7. The method of claim 1, wherein the at least one pre-defined action is selected from the group consisting of compensating a value of the at least one of the plurality of flight parameters based upon environmental data collected for the flight route, aborting the flight and returning to the Ground Control Station, and switching the at least one drone to a manual flight mode.

8. A system for monitoring an operational status of a drone, the system comprising:
a Ground Control Station, and
at least one drone communicably coupled to the Ground Control Station, the at least one drone being configured to:
capture statistical data for a flight route whilst flying substantially along the flight route at least once, the statistical data pertaining to a plurality of flight parameters;
transmit to a Ground Control Station the statistical data for the flight route from the at least one drone;
store reference data indicative of at least a minimum threshold and a maximum threshold for each of the plurality of flight parameters for the flight route;
capture flight data for the flight route and compare the flight data with the reference data, whilst flying substantially along the flight route; and
execute at least one pre-defined action, if at least one of the plurality of flight parameters for the flight route falls below its minimum threshold or exceeds its maximum threshold as indicated by the reference data;
wherein the Ground Control Station is configured to analyze the statistical data to determine at least a minimum threshold and a maximum threshold for each of the plurality of flight parameters.

9. The system of claim 8, wherein the Ground Control Station comprises a cloud computing system.

10. The system of claim 8, wherein the statistical data and the flight data are captured as a function of at least one of flight duration, and geo location.

11. The system of claim 8, wherein the reference data is indicative of at least the minimum threshold and the maximum threshold for each of the plurality of flight parameters as a function of at least one of flight duration, and geo location.

12. The system of claim 8, wherein the plurality of flight parameters include at least one of a temperature of an engine of a drone, a power consumption of the drone, a charging level of a battery of the drone, and sensor data measured by a configuration of sensors of the drone.

13. The system of claim 8, wherein the at least one drone is further configured to transmit the flight data from the at least one drone to the Ground Control Station, and the Ground Control Station is configured to augment the statistical data with the flight data, and wherein the at least one drone is further configured to update the reference data based upon the flight data of the at least one drone.

14. The system of claim 8, wherein the Ground Control Station is configured to collect environmental data for the flight route, wherein the environmental data is indicative of weather conditions prevailing at a geo location of the flight route at the time of the flight.

15. The system of claim 8, wherein the at least one pre-defined action is selected from the group consisting of compensating a value of the at least one of the plurality of flight parameters based upon environmental data collected for the flight route, aborting the flight and returning to the Ground Control Station, and switching the at least one drone to a manual flight mode.
